(19) United States
(12) Patent Application Publication
(10) Pub. No.: US 2013/0299739 A1
(43) Pub. Date: Nov. 14, 2013

(54) PROCESS FOR PRODUCING SURFACE POSTCROSSLINKED WATER-ABSORBING POLYMER PARTICLES

(71) Applicant: BASF SE, Ludwigshafen (DE)

(72) Inventors: Joseph Grill, Charlotte, NC (US); Patrick Hamilton, Charlotte, NC (US); William G-J Chiang, Charlotte, NC (US); Olaf Hoeller, Charlotte, NC (US)

(21) Appl. No.: 13/863,738

(22) Filed: Apr. 16, 2013

Related U.S. Application Data
(60) Provisional application No. 61/625,115, filed on Apr. 17, 2012.

(51) Int. Cl. B01J 20/32

(52) U.S. Cl. CPC B01J 20/3287
USPC 252/194; 106/287.17

(57) ABSTRACT

The invention relates to a process for producing surface postcrosslinked water-absorbing polymer particles, wherein the water-absorbing polymer particles are coated, before, during or after the surface postcrosslinking, with at least one basic salt of a trivalent metal cation and a monovalent carboxylic acid anion, wherein the basic salt is applied in the form of a solution that is stabilized by a vicinal diol and/or an amide of the formula R¹—CO—NR²R³ where R¹ is not H and in which R¹ is not H₂N— if both R² and R³ are H. Further, the invention relates to solutions of at least one basic salt that are stabilized by a vicinal diol and/or an amide of the formula R¹—CO—NR²R³ where R¹ is not H and in which R¹ is not H₂N— if both R² and R³ are H.

The present invention relates to a process for producing surface postcrosslinked water-absorbing polymer particles, wherein the water-absorbing polymer particles are coated, before, during or after the surface postcrosslinking, with at least one basic salt of a trivalent metal cation and a monovalent carboxylic acid anion.

Water-absorbing polymer particles are used to produce diapers, tampons, sanitary napkins and other hygiene articles, but also as water-retaining agents in market gardening. The water-absorbing polymer particles are also referred to as superabsorbents.

The production of water-absorbing polymer particles is described in the monograph “Modern Superabsorbent Polymer Technology”, F. L. Buchholz and A. T. Graham, Wiley-VCH, 1998, pages 71 to 103.

The properties of the water-absorbing polymer particles can be adjusted, for example, via the amount of crosslinker used. With the increasing amount of crosslinker, the centrifuge retention capacity (CRC) falls and the absorption under a pressure of 21.0 g/cm² (AUL0.3 psi) passes through a maximum.

To improve the performance properties, for example saline flow conductivity (SFC), gel bed permeability (GBP) and absorption under a pressure of 49.2 g/cm² (AUL0.7 psi), water-absorbing polymer particles are generally surface postcrosslinked (also referred to as “surface crosslinked”, the process also as “secondary crosslinking”). This increases the degree of crosslinking of the particle surface, which allows the absorption under a pressure of 49.2 g/cm² (AUL0.7 psi) and the centrifuge retention capacity (CRC) to be decoupled at least partly. This surface postcrosslinking can be carried out in aqueous gel phase. Preferably, however, dried, ground and sieved-off polymer particles (base polymer, i.e. the polymer prior to surface postcrosslinking) are surface coated with a surface postcrosslinker and thermally surface postcrosslinked. Crosslinkers suitable for this purpose are compounds which can form covalent bonds with at least two carboxylate groups of the water-absorbing polymer particles.

To improve the saline flow conductivity and/or gel bed permeability, the water-absorbing polymer particles are frequently coated with polyvalent metal cations before the thermal surface postcrosslinking. Such processes are known, for example, from WO 2000/053644 A1, WO 2000/053664 A1, WO 2005/108472 A1 and WO 2008/092843 A1.

WO 2010/108875 A1 describes a method for producing surface-post-crosslinked, water-absorbing polymer particles that are coated with at least one basic salt from a trivalent metal cation and a monovalent carboxylic anion. The basic salt may be stabilized with polyhydric alcohols such as mannitol and glycerol, soluble carbohydrates such as disaccharides and monosaccharides, polyvalent inorganic acids such as boric acid and phosphoric acid, hydroxycarboxylic acids or salts thereof, such as citric acid, lactic acid and tartaric acid or salts thereof, dicarboxylic acids or salts thereof, such as adipic acid and succinic acid, and urea and thiourea.

In a book titled “Ultrastructure Processing of Advanced Ceramics” (John D. Mackenzie and Donald R. Ulrich, eds., Wiley Interscience 1988), George F. Everitt reports in his chapter “Stabilized Aluminum Acetate used for an Alumina Source in Ceramic Fibers” about the synthesis of dibasic aluminum acetate (another name for aluminum monoacetate) and points out that boric acid plays the major role as stabilizer. Its effect is enhanced when combined with lactic acid and/or dimethyl formamide. U.S. Pat. No. 3,795,524 discloses a process for making aluminum borate and aluminum borosilicate articles starting from a ommercially available dibasic aluminum acetate solution stabilized by boric acid. In some embodiments, silica and dimethyl formamide are added to this solution.

It was an object of the present invention to provide another or improved process for producing water-absorbing polymer particles, especially high-permeability water-absorbing polymer particles. It was another object of this invention to provide other or improved stabilized solutions of basic salts.

Accordingly, the inventors have found a process for producing water-absorbing polymer particles by polymerizing a monomer solution or suspension comprising

a)at least one ethylenically unsaturated monomer which bears acid groups and may be at least partly neutralized,

b) at least one crosslinker,

c)at least one initiator,

d) optionally one or more ethylenically unsaturated monomers copolymerizable with the monomers specified under a) and

e) optionally one or more water-soluble polymers,

the process comprising drying, grinding, classifying and surface postcrosslinking, which comprises coating the water-absorbing polymer particles, before, during or after the surface postcrosslinking, with at least one basic salt of a trivalent metal cation and a monovalent carboxylic acid anion, wherein this basic salt is applied in the form of a solution that is stabilized by a vicinal diol and/or an amide of the formula R¹—CO—NR²R³ where R¹ is not H and in which R¹ is not H₂N— if both R² and R³ are H.

Further, the inventors have found stabilized solutions of basic salts, in which the basic salt is stabilized by a vicinal diol and/or an amide of the formula R¹—CO—NR²R³ where R¹ is not H and in which R¹ is not H₂N— if both R² and R³ are H.

In the basic salts, not all hydroxide groups eliminable as hydroxyl anions (OH⁻) in aqueous solutions in the salt-forming bases are replaced by acid groups.

The molar ratio of metal cation to carboxylic acid anion in the basic salts is typically from 0.4 to 10, preferably from 0.5 to 5, more preferably from 0.6 to 2.5, most preferably from 0.8 to 1.2.

The amount of trivalent metal cation used is preferably from 0.00004 to 0.05 mol per 100 g of the water-absorbing polymer particles to be coated, more preferably from 0.0002 to 0.03 mol per 100 g of the water-absorbing polymer particles to be coated, most preferably from 0.0008 to 0.02 mol per 100 g of the water-absorbing polymer particles to be coated.

The trivalent metal cation is preferably a metal cation of the third main group, of the third transition group or of the lanthanide group of the periodic table of the elements, more preferably aluminum, scandium, yttrium, lanthanum or cerium, most preferably aluminum.

The monovalent carboxylic acid anion is preferably the anion of a C₁- to C₄-alkanoic acid, more preferably the anion of formic acid (formate), of acetic acid (acetate), of propionic acid (propionate) and of butyric acid (butyrate), most preferably the anion of acetic acid.

Suitable basic salts of trivalent metal cation and monovalent carboxylic acid anion are, for example, basic aluminum formate, basic aluminum acetate and basic aluminum propionate. Very particular preference is given to aluminum monoacetate (CAS No. [7360-44-3]).

The basic salts of trivalent metal cation and monovalent carboxylic acid anion typically are applied to the water-absorbing polymer particles in the form of a solution. These salts, however, tend to be unstable in solution. In a laboratory environment, unstabilized, freshly prepared solutions are typically stable enough to be used for two to three hours or in some cases even up to six hours before they become a gel. This is too short even for many laboratory-scale applications and for most, if not all, commercial applications. Therefore, a stabilizer is typically added to these solutions to stabilize the salt. According to this invention, the stabilizer is a vicinal diol and/or an amide of the formula R¹—CO—NR²R³ where R¹ is not H and in which R¹ is not H₂N— if both R² and R³ are H.

A vicinal diol is a compound that bears two hydroxi groups on two carbon atoms that are directly bonded to each other. 1,2-diols such as ethylene glycol, 1,2-propylene glycol, 1,2-butylene glycol, cyclopentane-1,2-diol or cyclohexane-1,2-diol are typical and preferred examples. 1,2 propylene glycol is the particularly preferred vicinal diol.

In the context of this invention, an amide is a compound having the formula R¹—CO—NR²R³, in which R¹ is not H and in which R1 is not —NH₂ if both R² and R³ are H. Beyond that, R¹, R² and R³ are any substituted or unsubstituted organic or functional substituent. R² and R³ can also independently be H. R₁ preferably is an alkoxi, amiono or alkylthio group. R₁ and R₂ can also form a cyclic structure. In preferred embodiments, R¹ and R² form a five- or six-membered ring structure together with the keto group carbon and the nitrogen atom of the above structure. In particularly preferred embodiments, R₁ and R₂ together stand for a —O—CH₂—CH₂— or a —O—CH₂—CH₂—CH₂-group connecting the keto carbon and the nitrogen atom, the oxygen of the connecting group being attached to the keto group carbon, i.e. the amide is a five- or 6-membered carbamate ring. The hydrogens of the connecting group may be replaced by substitutents, for example by alkyl groups. If so, methyl, ethyl, iso-propyl or n-propyl groups are preferred. In a particularly preferred embodiment, the connecting group is —O—CH₂—CH₂—. In a particularly preferred embodiment, R3 is a alkyl group bearing at least one hydroxi substituent, most preferred is one hydroxi substituent at the C atom most distant from the nitrogen atom of the above formula. Examples are hydroximethyl, 2-hydroxiethyl, 3-hydroxipropyl or 4-hydroxibutyl groups. 2-Hydroxidethyl is most preferred. The most preferred amide structure according to this invention is N-(2-hydroxiethyl)-oxazolidin-2-one (also called “HEONON” for short).

In a particularly preferred embodiment of this invention, the vicinal diol and the amide are used as a mixture. The most preferred mixture is a mixture of 1,2-propylene glycol and HEONON.

As further explained below, HEONON is a known surface crosslinking agent for water-absorbing polymer particles. Quite surprisingly, it stabilizes the basic salts. Using vicinal diols and/or the amide stabilizers avoids certain disadvantages of known stabilizers such as toxicological concerns against boric acid or reduction in water-absorbing properties caused by polyacids.

Typically, the vicinal diol will be used in an amount of at least 0.01, preferably at least 0.1 and more preferably at least 0.2 and generally not more than 10, preferably not more than 5 and more preferably not more than 3 molar equivalents of the cation of the basic salt.

In general, the amide will be used in an amount of at least 0.01, preferably at least 0.05 and more preferably at least 0.1 and generally not more than 10, preferably not more than 5 and more preferably not more than 1 molar equivalents of the cation of the basic salt.

If HEONON is used as surface crosslinker for the water-absorbing polymer, too, the exact amount to be used may be determined according to an mount necessary to achieve the desired surface crosslinking.

The stabilized solution of this invention is a solution of the basic salt in a solvent. Any solvent or solvent mixture in which the basic salt is soluble is suitable as solvent. The preferred solvent is water. The stabilized solution of this invention is prepared by known methods, with the difference that the vicinal diol and/or the amide described above is or are added instead or in addition to other stabilizers. Preferably, no other stabilizers are used. The most usual method to prepare basic salts is reacting the proper stoichiometric amounts of metal powder with the hydrogen acid of the anion in the presence of the stabilizer. For example, dibasic aluminum acetate is prepared by reacting aluminum powder with one equivalent of acetic acid in the presence of the stabilizer and monobasic aluminum acetate (i.e. aluminum diacetate) by reacting aluminum powder with two equivalents of acetic acid. However, it is also possible to mix appropriate amounts of the corresponding base, for example aluminum hydroxide, and the corresponding carboxylic acid, for example acetic acid, in an aqueous solvent, for example water. Another known method to produce such basic salt is ion exchange between one or more salts of the desired cation and one or more salts of the desired anion(s). This is a particularly convenient method if the anion of the salt of the desired cation and the cation of the salt of the desired anion form a precipitate. For example, aluminum acetates can be produced by reacting aluminum sulfate, calcium hydroxide and calcium acetate in the proper stoichiometric amounts in aqueous solution in the presence of the stabilizer. Insoluble calcium sulfate will precipitate. In any case, undissolved precipitates and impurities are preferably removed by filtration.

In the process of this invention, the stabilized solution of this invention is applied to water-absorbing polymer particles.

The method of applying the basic salts of a trivalent metal cation and a monovalent carboxylic acid anion to the water-absorbing polymer particles is not subject to any restriction. Generally, the solution will by applied in a mixer to achieve homogeneous distribution. Suitable mixers are, for example, horizontal Pflugschar® mixers (Gebr. Lödige Maschinenbau GmbH; Paderborn; Germany), Vrieco-Nauta Continuous Mixers (Hosokawa Micron BV; Doetinchem; the Netherlands), Processall Mixmill Mixers (Processall Incorporated; Cincinnati; US), Schugi Flexomix® (Hosokawa Micron BV; Doetinchem; the Netherlands), Hosokawa Bepex® Horizontal Paddle Dryers (Hosokawa Micron GmbH; Leingarten; Germany), Hosokawa Bepex® Disc Dryers (Hosokawa Micron GmbH; Leingarten; Germany) and Nara Paddle Dryers (NARA Machinery Europe; Frechen; Germany).

The inventive coating is advantageous especially when the temperature of the water-absorbing polymer particles after the coating is preferably at least 120° C., more preferably at least 150° C., most preferably at least 180° C. Such temperatures occur typically when the coating is performed before or during the thermal surface postcrosslinking.

The basic salt of a trivalent metal cation and a monovalent carboxylic acid anion is used as a solution in a solvent, preferably an aqueous solution. The aqueous solutions are prepared, for example, by dissolving or preparing the appropriate basic salts in an aqueous solvent, for example water.

The water content of the aqueous solution is preferably from 60 to 98% by weight, more preferably from 65 to 90% by weight, most preferably from 70 to 85% by weight. In order to increase the solubility in the aqueous solution, the solution can be prepared and used at elevated temperature.

In a preferred embodiment of the present invention, the aqueous solution comprising at least one basic salt of a trivalent metal cation and a monovalent carboxylic acid anion, and the surface postcrosslinker, are applied to the water-absorbing polymer particles in the same mixer. The aqueous solution and the surface postcrosslinker can be metered in separately or else as a combined solution. Particularly if HEONON is used as surface postcrosslinker, the basic salt solution and the surface postcrosslinker are applied as one combined solution.

In a further preferred embodiment of the present invention, the at least one basic salt of a trivalent metal cation and a monovalent carboxylic acid anion is applied only after the surface postcrosslinking.

It is possible by means of the process according to the invention to achieve a gel bed permeability (GBP) without lowering the absorption under a pressure of 49.2 g/cm² (AUL0.7 psi).

Particularly advantageously, water-absorbing polymer particles are coated before the surface postcrosslinking with aluminum lactate and after the surface postcrosslinking with aluminum monoacetate. Coating with aluminum lactate increases the saline flow conductivity (SFC) and the absorption under a pressure of 49.2 g/cm² (AUL0.7 psi). Subsequent coating with aluminum monoacetate increases the gel bed permeability (GBP).

The water-absorbing polymer particles are produced by polymerizing a monomer solution or suspension and are typically water-insoluble.

The monomers a) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomers a) typically comprise polymerization inhibitors, preferably hydroquinone half ethers, as storage stabilizers.

The monomer solution comprises preferably up to 250 ppm by weight, preferably at most 130 ppm by weight, more preferably at most 70 ppm by weight, preferably at least 10 ppm by weight, more preferably at least 30 ppm by weight, especially around 50 ppm by weight, of hydroquinone half ether, based in each case on the unneutralized monomer a). For example, the monomer solution can be prepared by using an ethylenically unsaturated monomer bearing acid groups with an appropriate content of hydroquinone half ether.

Preferred hydroquinone half ethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraalloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably from 0.05 to 1.5% by weight, more preferably from 0.1 to 1% by weight, most preferably from 0.3 to 0.6% by weight, based in each case on monomer a). With rising crosslinker content, the centrifuge retention capacity (CRC) falls and the absorption under a pressure of 21.0 g/cm² (AUL0.3 psi) passes through a maximum.

The initiators c) may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite. Such mixtures are obtainable as Brüggolite® FF6 and Brüggolite® FF7 (Brüggemann Chemicals; Heilbronn; Germany).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight, most preferably from 50 to 65% by weight. It is also possible to use monomer suspensions, i.e. monomer solutions with excess monomer a), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. Before the polymerization, the monomer solution can therefore be freed of dissolved oxygen, and the polymerization inhibitor present in the monomer solution can be deactivated, by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. Polymerization on a belt is described, for example, in DE 38 25 366 A1 and U.S. Pat. No. 6,241,928. Polymerization in a belt reactor forms a polymer gel, which has to be comminuted in a further process step, for example in an extruder or kneader.

However, it is also possible to dropletize an aqueous monomer solution and to polymerize the droplets obtained in a heated carrier gas stream. This allows the process steps of polymerization and drying to be combined, as described in WO 2008/040715 A2 and WO 2008/052971 A1.

The acid groups of the resulting polymer gels have typically been partially neutralized. Neutralization is preferably carried out at the monomer stage. This is typically done by mixing in the neutralizing agent as an aqueous solution or preferably also as a solid. The degree of neutralization is preferably from 25 to 95 mol %, more preferably from 30 to 80 mol %, most preferably from 40 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably from 10 to 30 mol % and more preferably from 15 to 25 mol % of the acid groups before the polymerization by adding a portion of the neutralizing agent actually to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The polymer gel is then preferably dried with a belt dryer until the residual moisture content is preferably from 0.5 to 15% by weight, more preferably from 1 to 10% by weight, most preferably from 2 to 8% by weight, the residual moisture content being determined by the EDANA recommended test method No. WSP 230.2-05 “Moisture Content”. In the case of too high a residual moisture content, the dried polymer gel has too low a glass transition temperature T_{g} and can be processed further only with difficulty. In the case of too low a residual moisture content, the dried polymer gel is too brittle and, in the subsequent comminution steps, undesirably large amounts of polymer particles with an excessively low particle size are obtained (fines). The solids content of the gel before the drying is preferably from 25 to 90% by weight, more preferably from 35 to 70% by weight, most preferably from 40 to 60% by weight. Optionally, it is, however, also possible to use a fluidized bed dryer or a paddle dryer for the drying operation.

Thereafter, the dried polymer gel is ground and classified, and the apparatus used for grinding may typically be single- or multistage roll mills, preferably two- or three-stage roll mills, pin mills, hammer mills or vibratory mills.

The mean particle size of the polymer particles removed as the product fraction is preferably at least 200 μm, more preferably from 250 to 600 μm, very particularly from 300 to 500 μm. The mean particle size of the product fraction may be determined by means of the EDANA recommended test method No. WSP 220.2-05 “Particle Size Distribution”, where the proportions by mass of the screen fractions are plotted in cumulated form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (fines) should therefore be small.

Excessively small polymer particles are therefore typically removed and recycled into the process. This is preferably done before, during or immediately after the polymerization, i.e. before the drying of the polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

When a kneading reactor is used for the polymerization, the excessively small polymer particles are preferably added during the last third of the polymerization.

When the excessively small polymer particles are added at a very early stage, for example actually to the monomer solution, this lowers the centrifuge retention capacity (CRC) of the resulting water-absorbing polymer particles. However, this can be compensated, for example, by adjusting the amount of crosslinker b) used.

When the excessively small polymer particles are added at a very late stage, for example not until within an apparatus connected downstream of the polymerization reactor, for example an extruder, the excessively small polymer particles can be incorporated into the resulting polymer gel only with difficulty. Excessively small polymer particles which have been insufficiently incorporated, however, become detached again from the dried polymer gel during the grinding, and are therefore removed again in the classification and increase the amount of excessively small polymer particles to be recycled.

The proportion of particles having a particle size of at most 850 μm is preferably at least 90% by weight, more preferably at least 95% by weight, most preferably at least 98% by weight.

Advantageously, the proportion of polymer particles with a particle size of at most 600 μm is preferably at least 90% by weight, more preferably at least 95% by weight, most preferably at least 98% by weight.

Polymer particles with too great a particle size lower the swell rate. The proportion of excessively large polymer particles should therefore likewise be small.

Excessively large polymer particles are therefore typically removed and recycled into the grinding of the dried polymer gel.

To further improve the properties, the polymer particles are surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidone and its derivatives, such as 2-hydroxyethyl-2-oxazolidone in DE 198 07 502 A1, bis- and poly-2-oxazolidinones in DE 198 07 992 C1, 2-oxotetrahydro-1,3-oxazine and its derivatives in DE 198 54 573 A1, N-acyl-2-oxazolidones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and its derivatives in WO 2003/031482 A1.

Preferred surface postcrosslinkers are glycerol, ethylene carbonate, ethylene glycol diglycidyl ether, reaction products of polyamides with epichlorohydrin, and mixtures of propylene glycol and 1,4-butanediol.

Very particularly preferred surface postcrosslinkers are 2-hydroxyethyloxazolidin-2-one, oxazolidin-2-one and 1,3-propanediol.

In addition, it is also possible to use surface postcrosslinkers which comprise additional polymerizable ethylenically unsaturated groups, as described in DE 37 13 601 A1.

The amount of surface postcrosslinker is preferably from 0.001 to 2% by weight, more preferably from 0.02 to 1% by weight, most preferably from 0.05 to 0.2% by weight, based in each case on the polymer particles.

In the present invention, before, during or after the surface postcrosslinking, in addition to the surface postcrosslinkers, at least one basic salt of a trivalent metal cation and a monovalent carboxylic acid anion is applied to the particle surface.

It will be appreciated that it is also additionally possible to use further polyvalent cations. Suitable polyvalent cations are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogenphosphate and carboxylate, such as acetate and lactate. Aluminum sulfate and aluminum lactate are preferred. It is also possible to use polyamines as further polyvalent cations.

The surface postcrosslinking is typically performed in such a way that a solution of the surface postcrosslinker is sprayed onto the dried polymer particles. After the spraying, the polymer particles coated with surface postcrosslinker are dried thermally, and the surface postcrosslinking reaction can take place either before or during the drying.

The spraying of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta Continuous Mixers (Hosokawa Micron BV; Doetinchem; the Netherlands), Processall Mixmill Mixers (Processall Incorporated; Cincinnati; US) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The penetration depth of the surface postcrosslinker into the polymer particles can be adjusted via the content of nonaqueous solvent and total amount of solvent.

When exclusively water is used as the solvent, a surfactant is advantageously added. This improves the wetting behavior and reduces the tendency to form lumps. However, preference is given to using solvent mixtures, for example isopropanol/water, 1,3-propanediol/water and propylene glycol/water, where the mixing ratio in terms of mass is preferably from 20:80 to 40:60.

The thermal drying is preferably carried out in contact dryers, more preferably paddle dryers, most preferably disk dryers. Suitable dryers are, for example, Hosokawa Bepex® Horizontal Paddle Dryers (Hosokawa Micron GmbH; Leingarten; Germany), Hosokawa Bepex® Disc Dryers (Hosokawa Micron GmbH; Leingarten; Germany) and Nara Paddle Dryers (NARA Machinery Europe; Frechen; Germany). Moreover, it is also possible to use fluidized bed dryers.

The drying can be effected in the mixer itself, by heating the jacket or blowing in warm air. Equally suitable is a downstream dryer, for example a shelf dryer, a rotary tube oven or a heatable screw. It is particularly advantageous to mix and dry in a fluidized bed dryer.

Preferred drying temperatures are in the range from 100 to 250° C., preferably from 120 to 220° C., more preferably from 130 to 210° C., most preferably from 150 to 200° C. The preferred residence time at this temperature in the reaction mixer or dryer is preferably at least 10 minutes, more preferably at least 20 minutes, most preferably at least 30 minutes, and typically at most 60 minutes.

To further improve the properties, the surface postcrosslinked polymer particles can be coated or subsequently moistened.

The subsequent moistening is carried out preferably at from 30 to 80° C., more preferably at from 35 to 70° C. and most preferably at from 40 to 60° C. At excessively low temperatures, the water-absorbing polymer particles tend to form lumps, and, at higher temperatures, water already evaporates noticeably. The amount of water used for subsequent moistening is preferably from 1 to 10% by weight, more preferably from 2 to 8% by weight and most preferably from 3 to 5% by weight. The subsequent moistening increases the mechanical stability of the polymer particles and reduces their tendency to static charging.

Suitable coatings for improving the swell rate and the saline flow conductivity (SFC) and/or gel bed permeability (GBP) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, and surfactants, such as Span® 20.

Subsequently, the surface postcrosslinked polymer particles can be classified again to remove excessively small and/or excessively large polymer particles which are recycled into the process.

The water-absorbing polymer particles are tested by means of the test methods described below.

### Methods:

The measurements should, unless stated otherwise, be carried out at an ambient temperature of 23±2° C. and a relative air humidity of 50±10%. The water-absorbing polymer particles are mixed thoroughly before the measurement.

### Saline Flow Conductivity (“SFC”)

The saline flow conductivity (SFC) of a swollen gel layer under a pressure of 0.3 psi (2070 Pa) is, as described in EP 0 640 330 A1 (page 19, line 13 to page 21, line 35), determined as the gel layer permeability of a swollen gel layer of water-absorbing polymer particles, with modification of the apparatus described in FIG. 8 in that the glass frit (40) is not used, the plunger (39) consists of the same plastic material as the cylinder (37), and now has 21 bores of equal size distributed homogeneously over the entire contact area. The procedure and evaluation of the measurement remain unchanged from EP 0 640 330 A1. The flow is detected automatically.

The saline flow conductivity (SFC) is calculated as follows:

SFC[cm³s/g]=(Fg(t=0)×L0)/(d×A×WP)

where Fg(t=0) is the flow of NaCl solution in g/s, which is obtained using a linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

### Gel Bed Permeability (“GBP”)

The gel bed permeability (GBP) of a swollen gel layer under a pressure of 0.3 psi (2070 Pa) is, as described in US 2007/0135785 (paragraphs [0151] and [0152]), determined as the gel bed permeability of a swollen gel layer of water-absorbing polymer particles.

### Centrifuge Retention Capacity (“CRC”)

The centrifuge retention capacity (CRC) is determined by the EDANA recommended test method No. WSP 214.2-05 “Centrifuge Retention Capacity”.

Absorption Under a Pressure of 63.3 g/cm² (“AUL0.9 psi”)

The absorption under a pressure of 63.3 g/cm² (commonly referred to as “AUL0.9 psi”) is determined according to the EDANA (European Disposables and Nonwovens Association) recommended test method No. WSP 242.2-05 “Absorption under Pressure”, however, with a pressure setting of 63.3 g/cm² (AUL0.9 psi) instead of 21.0 g/cm² (that corresponds to the AUL0.3 psi).

### EXAMPLES

### Example 1

### Laboratory Procedure for Producing Aluminum Monoacetate Solution Stabilized with 1,2-propylene glycol

Following the Stoichiometry:

Al₂(SO₄)₃(aq.)+Ca(OAc)₂+2Ca(OH)₂→2Al(OAc)(OH)₂(aq.)+3CaSO₄(ppt.)

(OAc being an acetate anion), 100 g aqueous aluminum sulfate solution (26.41 wt.-%) was placed in a 250-mL beaker with an overhead stirrer. The beaker was cooled in an ice bath to 5° C. with stirring. 13.61 g calcium acetate monohydrate powder was added in one portion and the slurry was allowed to stir for 15 minutes. 23.8 g 1,2-propylene glycol were added as stabilizer. 11.44 g calcium hydroxide were added slowly over 30-45 minutes while maintaining the reaction temperature at 10° C. or less. Once addition of the calcium hydroxide was complete, the slurry was allowed to stir in the ice bath for 30 minutes. The slurry was stirred at room temperature for 30 minutes and then filtered using a Buchner funnel. The solid calcium sulfate was discarded and the solution was collected for use.

The theoretical aluminum monoacetate concentration was calculated to be 15.8 wt.-%. Since no great efforts were taken to recover all of the solution from the calcium sulfate precipitate, actual yields of solution ranged from 40 to 60% of the 117.35 g that can be expected in theory.

### Example 2

Following the procedure of Example 1, aluminum acetate solutions were prepared with other stabilizers. Due to the varying amount of stabilizer, the aluminum monoacetate concentration in the obtained solutions was between 12 and 20 wt.-%. The solutions were tested for stability at room temperature and at 60° C. The time until a precipitate formed at these temperatures was noted. The results are summarized in the following table.

| | Stabilizer amount | | | |
|---|---|---|---|---|
| | (molar equivalents | Stability | | |
| | relative | at room | Stability at | |
| Stabilizer | to aluminum) | temperature | 60° C. | |
| None*⁾ | | 2-3 hours | <10 | minutes |
| boric acid*⁾ | 1 | Indefinite | >8 | hours |
| sodium citrate*⁾ | 1 | Indefinite | >8 | hours |
| dimethyl | 1 | Indefinite | >8 | hours |
| formamide*⁾ | | | | |
| dimethyl | 0.50 | Indefinite | >8 | hours |
| formamide*⁾ | | | | |
| 3-methyl-2- | 1 | Indefinite | >8 | hours |
| oxazolidinone | | | | |
| 3-methyl-2- | 0.50 | Indefinite | >8 | hours |
| oxazolidinone | | | | |
| 1,2-propylene glycol | 2 | Indefinite | >8 | hours |
| 1,2-propylene glycol | 1 | Indefinite | 3-4 | hours |
| HEONON | 1 | Indefinite | >8 | hours |
| HEONON | 0.50 | Indefinite | >8 | hours |
| HEONON | 0.25 | Indefinite | >3-4 | hours |
| HEONON | 0.10 | 48 hours | 1-2 | hours |
| HEONON | 0.10 | Indefinite | >8 | hours |
| 1,2-propylene glycol | 1 | | | |
| HEONON | 0.10 | Indefinite | >8 | hours |
| 1,2-propylene glycol | 2 | | | |

*⁾comparative examples

The results show that using the stabilizers according to this invention results in stable solutions.

### Example 3

A base polymer (i.e. a non-surface crosslinked superabsorbent) (Hysorb® T8760, available from BASF Corporation, Freeport, Tex., U.S.A.) was placed in a Lödige® laboratory mixer and heated to 50° C. A solution consisting of 0.69 wt.-% aluminum monoacetate prepared as a solution following the procedure of Example 1, but using the stabilizers listed in the table below, 0.14 wt.-% of a mixture of HEONON and 1,3-propanediol (50 wt.-% each in this mixture), 0.9 wt.-% 1,2 propylene glycol and 3.31 wt.-% water (all amounts calculated relative to the weight of base polymer to be coated), was sprayed onto the heated base polymer at a stirrer speed of 450 rpm, which was mixed at this speed for a further 30 seconds. This was followed by mixing at a setting of 200 rpm for a further two minutes. Subsequently, the moist polymer particles were heated rapidly to a product temperature of 180° C. and cured while mixing for a further 60 minutes. The surface postcrosslinked polymer particles were cooled to ambient temperature and screened off to a particle size of 300 to 600 μm.

The procedure was repeated using different stabilizers for aluminum monoacetate. The resulting water-absorbing polymers had the properties summarized in the following table:

| | Stabilizer amount | | | |
|---|---|---|---|---|
| | (molar equivalents | | | |
| Stabilizer | relative to aluminum) | CRC | AUL0.9 psi | GBP |
| no stabilizer*⁾**⁾ | — | 34.2 | 19.3 | 55 |
| boric acid*⁾ | 0.2 | 34.0 | 19.5 | 57 |
| sodium citrate*⁾ | 0.2 | 33.4 | 19.9 | 38 |
| 1,2-propylene glycol | 1 | 33.8 | 19.5 | 51 |
| 1,2 propylene glycol | 2 | 33.9 | 19.2 | 50 |
| HEONON | 0.10 | | | |
| 1,3-propane diol | 0.10 | | | |

*⁾comparative examples
**⁾i.e. freshly prepared solution

These experiments show that water-absorbing polymers produced using a base salt solutions stabilized with sodium citrate exhibit unacceptably low GBP. The water-absorbing polymers produced in accordance with this invention exhibit good absorption parameters and avoid the toxicological concerns against boric acid.

1. A process for producing water-absorbing polymer particles by polymerizing a monomer solution or suspension comprising
a) at least one ethylenically unsaturated monomer which bears an acid group and may be at least partly neutralized,
b) at least one crosslinker,
c) at least one initiator,
d) optionally one or more ethylenically unsaturated monomer copolymerizable with the monomer specified under a) and
e) optionally one or more water-soluble polymer, the process comprising drying, grinding, classifying, and surface postcrosslinking, which comprises coating the water-absorbing polymer particles, before, during, or after the surface postcrosslinking, with at least one basic salt of a trivalent metal cation and a monovalent carboxylic acid anion, wherein the basic salt is applied in the form of a solution stabilized by a vicinal diol and/or an amide of the formula R¹—CO—NR²R³, wherein R¹ is different from H and in which R¹ is different from H₂N— when both R² and R³ are H.

2. The process according to claim 1, wherein from 0.00004 to 0.05 mol of the trivalent metal cation is used per 100 g of the water-absorbing polymer particles to be coated.

3. The process according to claim 1, wherein the trivalent metal cation is an aluminum cation.

4. The process according to claim 1, wherein the monovalent carboxylic acid anion is an acetate anion.

5. The process according to claim 1, wherein the solution is an aqueous solution.

6. A stabilized solution of at least one basic salt of a trivalent metal cation and a monovalent carboxylic acid anion, wherein the stabilizer is a vicinal diol and/or an amide of the formula R¹—CO—NR²R³, wherein R¹ is different from H and in which R¹ is different from H₂N— when both R² and R³ are H.

7. The stabilized solution of claim 6, wherein the vicinal diol is 1,2-propylene glycol.

8. The stabilized solution of claim 6, wherein the amide is N-(2-hydroxyethyl)-oxazolidin-2-one.

9. The stabilized solution of claim 6 wherein the solution is an aqueous solution.

10. The stabilized solution of claim 6, wherein the solution is an aqueous solution of aluminum monoacetate stabilized by 1,2-propylene glycol and N-(2-hydroxyethyl)-oxazolidin-2-one.
